(19) United States
(12) Patent Application Publication
(10) Pub. No.: US 2020/0310202 A1
(43) Pub. Date: Oct. 1, 2020

(54) PIXEL STRUCTURE AND LIQUID CRYSTAL DISPLAY PANEL

(71) Applicants: HKC Corporation Limited, Shenzhen City (CN); Chongqing HKC Optoelectronics Technology Co.,ltd., Chongqing (CN)

(72) Inventor: ChunHui Yang, Chongqing (CN)

(21) Appl. No.: 16/772,893

(22) PCT Filed: Sep. 11, 2018
(86) PCT No.: PCT/CN2018/105058

§ 371 Date: Jun. 15, 2020

(30) Foreign Application Priority Data
Dec. 12, 2017 (CN) 201711391889.0

(51) Int. Cl. G02F 1/1343; G09G 3/36; G02F 1/1362

(52) U.S. Cl. CPC G02F 1/134309; G09G 3/3677; G02F 2201/123; G02F 1/136286; G02F 1/13624; G09G 3/3688

(57) ABSTRACT

A pixel structure and a liquid crystal display panel are provided. The pixel structure includes a scan line, a data line disposed intersecting with the scan line, and a pixel unit disposed at an intersection of the scan line and the data line. The pixel unit includes an active switch group and a pixel electrode group. The pixel electrode group includes: a first electrode region disposed with mutually crossed and communicated hollow long slots to form first electrode sub-regions and a second electrode region disposed with mutually crossed solid main parts to form second electrode sub-regions. Each first electrode sub-region has short slots disposed in parallel and inclined relative to the hollow long slots. Each second electrode sub-region has slits disposed in parallel and inclined relative to the solid main parts.

### FIELD OF THE DISCLOSURE

The disclosure relates to the field of display technology, and more particularly to a pixel structure and a liquid crystal display panel.

### BACKGROUND

Liquid crystal display devices have advantages such as high-quality picture, small size, light weight, low voltage-driven, low power consumption and wide range of applications, and thus have been widely used in consumer electronics or computer products such as small and medium sized portable TVs, mobile phones, camcorders, notebook computers, desktop monitors and projection TVs, and further have gradually become the mainstream instead of cathode ray tube (CRT) display devices. As a display part of a liquid crystal display device, the VA (vertical alignment) type panel has advantages of wide viewing angle, high contrast and no need of rubbing orientation and thus is widely used in large-size display devices. However, the conventional VA type panel still has shortcomings such as relatively narrow viewing angle range and relatively low contrast, which is one of the topics currently expected to be improved.

### SUMMARY

Accordingly, embodiments of the disclosure provide a pixel structure and a liquid crystal display panel, so as to achieving the technical effect of increasing the viewing angle.

In one aspect, an embodiment of the disclosure provides a pixel structure including: a scan line; a data line, disposed intersecting with the scan line; and a pixel unit, disposed at an intersection of the scan line and the data line. The pixel unit includes an active switch group and a pixel electrode group, the pixel electrode group is connected to the scan line and the data line through the active switch group. The pixel electrode group includes: a first electrode region, disposed with mutually crossed and communicated hollow long slots to form a plurality of first electrode sub-regions, each of the first electrode sub-regions has a plurality of short slots disposed in parallel and inclined relative to the hollow long slots, and the short slots of the respective first electrode sub-regions have different orientation directions; and a second electrode region, disposed with mutually crossed solid main parts to form a plurality of second electrode sub-regions, each of the second electrode sub-regions has a plurality of slits disposed in parallel and inclined relative to the solid main parts, and the slits of the respective second electrode sub-regions having different orientation directions. The active switch group includes an active switching element, the pixel electrode group includes a pixel electrode, and the pixel electrode is connected to the scan line and the data line through the active switching element. The pixel electrode group further includes: a third electrode region, disposed with mutually crossed and communicated second hollow long slots to form a plurality of third electrode sub-regions, each of the third electrode sub-regions has a plurality of second short slots disposed in parallel and inclined relative to the second hollow long slots, and the second short slots of the respective third electrode sub-regions have different orientation directions. The first electrode region, the second electrode region and the third electrode region are different parts of the same pixel electrode. The third electrode region is located between the first electrode region and the second electrode region, and the sum of areas of the first electrode region and the third electrode regions is equal to an area of the second electrode region; or, the third electrode region is located between the first electrode region and the second electrode region, and the first electrode region, the second electrode region and the third electrode region have equal areas; or, the second electrode region is located between the first electrode region and the third electrode region, and the first electrode region, the second electrode region and the third electrode region have equal areas.

In another aspect, another embodiment of the disclosure provides a pixel structure including: a scan line; a data line, disposed intersecting with the scan line; and a pixel unit, disposed at an intersection of the scan line and the data line, wherein the pixel unit includes an active switch group and a pixel electrode group, the pixel electrode group is connected to the scan line and the data line through the active switch group. The pixel electrode group includes: a first electrode region, disposed with mutually crossed and communicated hollow long slots to form a plurality of first electrode sub-regions, each of the first electrode sub-regions has a plurality of short slots disposed in parallel and inclined relative to the hollow long slots, and the short slots of the respective first electrode sub-regions have different orientation directions; and a second electrode region, disposed with mutually crossed solid main parts to form a plurality of second electrode sub-regions, each of the second electrode sub-regions has a plurality of slits disposed in parallel and inclined relative to the solid main parts, and the slits of the respective second electrode sub-regions having different orientation directions.

In an embodiment of the disclosure, the active switch group includes an active switching element, the pixel electrode group includes a pixel electrode, and the pixel electrode is connected to the scan line and the data line through the active switching element; the first electrode region and the second electrode regions respectively are two parts of the same pixel electrode with equal areas.

In an embodiment of the disclosure, the active switch group includes an active switching element, the pixel electrode group includes a pixel electrode, and the pixel electrode is connected to the scan line and the data line through the active switching element. The pixel electrode group further includes: a third electrode region, disposed with mutually crossed and communicated second hollow long slots to form a plurality of third electrode sub-regions, each of the third electrode sub-regions has a plurality of second short slots disposed in parallel and inclined relative to the second hollow long slots, and the second short slots of the respective third electrode sub-regions have different orientation directions. The first electrode region, the second electrode region and the third electrode region respectively are different parts of the same pixel electrode.

In an embodiment of the disclosure, the sum of areas of the first electrode region and the third electrode region is equal to an area of the second electrode region.

In an embodiment of the disclosure, the third electrode region is located between the first electrode region and the second electrode region.

In an embodiment of the disclosure, the third electrode region is located between the first electrode region and the second electrode region, and areas of the first electrode region, the second electrode region and the third electrode region are equal.

In an embodiment of the disclosure, the second electrode region is located between the first electrode region and the third electrode region, and areas of the first electrode region, the second electrode region and the third electrode region are equal.

In an embodiment of the disclosure, the active switch group includes an active switching element, the pixel electrode group includes a pixel electrode, and the pixel electrode is connected to the scan line and the data line through the active switching element. The pixel electrode group further includes: a third electrode region, disposed with mutually crossed second solid main parts to form a plurality of third electrode sub-regions, each of the third electrode sub-regions has a plurality of second slits disposed in parallel and inclined relative to the second solid main parts, and the second slits of the respective third electrode sub-regions have different orientation directions. The first electrode region, the second electrode region and the third electrode region respectively are different parts of the same pixel electrode.

In an embodiment of the disclosure, the first electrode region is located between the second electrode region and the third electrode region, and areas of the first electrode region, the second electrode region and the third electrode region are equal.

In an embodiment of the disclosure, the active switch group includes a first active switching element and a second active switching element, the pixel electrode group includes a first pixel electrode and a second pixel electrode spaced apart from each other, the first pixel electrode is connected to the scan line and the data line through the first active switching element, the second pixel electrode is connected to the scan line and the data line through the second active switching element; the first electrode region is used as the first pixel electrode, and the second electrode region is used as the second pixel electrode.

In an embodiment of the disclosure, an area of the first electrode region is different from an area of the second electrode region.

In an embodiment of the disclosure, a ratio of the area of the first electrode region to the area of the second electrode region is 2:3 or 3:2.

In still another aspect, an embodiment of the disclosure provides a liquid crystal display panel including: an active switch array substrate including a plurality of pixel structures; a counter substrate disposed opposite to the active switch array substrate; a liquid crystal layer disposed between the active switch array substrate and the counter substrate. At least one pixel structure in the plurality of pixel structures is the pixel structure associated with the above embodiments.

By adopting the above technical solution that a pixel electrode(s) of one pixel structure is/are disposed with pixel electrode regions with two different structures, so that the pixel structure can have the characteristics of two types of pixel electrodes and thereby the display panel adopting such pixel structure is endowed with advantages of wide viewing angle and high contrast.

### BRIEF DESCRIPTION OF THE DRAWINGS

In order to more clearly illustrate technical solutions of embodiments of the disclosure, drawings to be used in the description of the embodiments will be briefly described. Apparently, the drawings in the description below are merely some embodiments of the disclosure, a person skilled in the art can obtain other drawings according to these drawings without creative efforts.

FIG. 1 is a schematic view of a layout of a pixel structure according to an embodiment of the disclosure.

FIG. 2 is a schematic view of a layout of a pixel structure according to another embodiment of the disclosure.

FIG. 3 is a schematic view of a layout of a pixel structure according to still another embodiment of the disclosure.

FIG. 4 is a schematic view of a layout of a pixel structure according to further still another embodiment of the disclosure.

FIG. 5 is a schematic view of a layout of a pixel structure according to even further still another embodiment of the disclosure.

FIG. 6 is a schematic view of a layout of a pixel structure according to further another embodiment of the disclosure.

FIG. 7 is a schematic structural view of a liquid crystal display panel according to other embodiment of the disclosure.

### DETAILED DESCRIPTION OF EMBODIMENTS

Technical solutions in embodiments of the disclosure will be clearly and completely described below in conjunction with accompanying drawings of the disclosure. Apparently, the described embodiments are only some of embodiments of the disclosure rather than all of the embodiments. Based upon the described embodiments of the disclosure, all other embodiments obtained by a person skilled in the art without creative effects should be within the scope of protection of the disclosure.

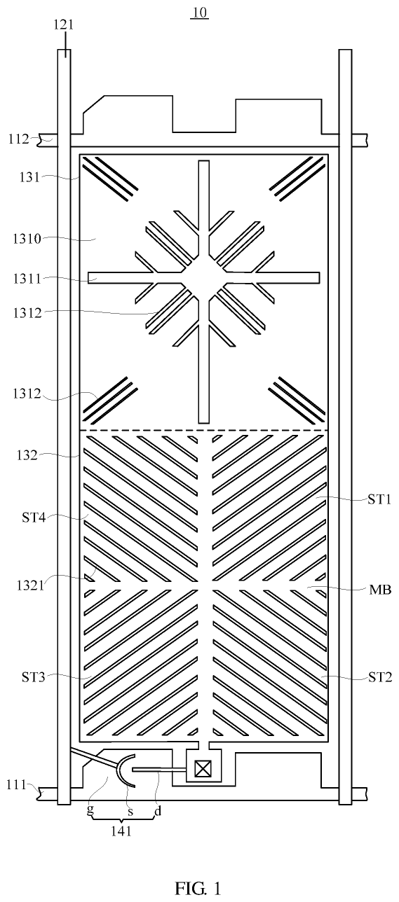

Referring to FIG. 1, a pixel structure 10 provided by an embodiment of the disclosure includes: a scan line 111, a data line 121 disposed intersecting with the scan line 111, and a pixel unit disposed at an intersection of the scan line 111 and the data line 121. The pixel unit includes an active switch group and a pixel electrode group, and the pixel electrode group is connected to the scan line 111 and the data line 121 through the active switch group.

The pixel electrode group includes a first electrode region 131 and a second electrode region 132. The first electrode region 131 is disposed with mutually crossed and communicated hollow long slots 1311 to form multiple (i.e., more than one) first electrode sub-regions 1310. Each of the first electrode sub-regions 1310 has multiple short slots 1312 disposed in parallel and inclined relative to the hollow long slots 1311. The short slots 1312 of the respective first electrode sub-regions 1310 have different orientation directions. The second electrode region 132 is disposed with mutually crossed solid main parts MB to form multiple second electrode sub-regions, and in the illustrated embodiment, there is four second electrode sub-regions in total, as shown in FIG. 1, including ST1, ST2, ST3 and ST4, each of the four second electrode sub-regions has multiple slits 1321 disposed in parallel and inclined relative to the solid main parts MB. Orientation directions of the slits 1321 of the four second electrode sub-regions ST1, ST2, ST3 and ST4 respectively are different from each other.

The first electrode region 131 includes crossed e.g., perpendicularly crossed and mutually communicated two long slots 1311 and multiple short slots 1312 with different orientation directions, and the short slots 1312 for example are formed laterally extending from the two long slots 1311; and the pixel electrode in the electrode region usually is snowflake-shaped and thus can be called as snowflake-shaped electrode.

The second electrode region 132 includes crossed main parts MB to form four electrode sub-regions ST1, ST2, ST3 and ST4, and slits 1321 of the fourth electrode sub-regions have different orientation directions. In particular, the second electrode region 132 for example includes crossed e.g., criss-crossed main parts MB to form four electrode sub-regions i.e., ST1, ST2, ST3 and ST4, orientation directions of the slits 1321 of the respective electrode sub-regions are mutually different, e.g., respectively are 45 degrees of orientation direction, 135 degrees of orientation direction, 225 degrees of orientation direction and 315 degrees of orientation direction; and the pixel electrode in the electrode region usually is a four-domain electrode.

The active switch group includes an active switching element 141. The pixel electrode group includes a pixel electrode. In the illustrated embodiment, the pixel electrode typically is a transparent electrode such as an ITO (indium tin oxide) electrode. A source electrode s of the active switching element 141 is connected to the data line 121, a gate electrode g of the active switching element 141 is connected to the scan line 111, and a drain electrode d of the active switching element 141 is connected to the pixel electrode.

The first electrode region 131 and the second electrode region 132 respectively are two parts of the same pixel electrode with equal areas. In other words, the areas of the first electrode region 131 and the second electrode region 132 are the same. In particular, the second electrode region 132 may be disposed near the scan line 111 and at the bottom of the pixel electrode as shown in FIG. 1, the first electrode region 131 is disposed near another scan line 112 and at the top of the pixel electrode. Of course, the positions of the first electrode region 131 and the second electrode region 132 may be interchangeable, i.e., the second electrode region 132 is disposed near the scan line 112 and at the top of the pixel electrode, and the first electrode region 131 is disposed near the scan line 111 and at the bottom of the pixel electrode.

Sum up, the pixel structure 10 provided by the embodiment disposes two pixel electrode parts with equal areas but different structures in the pixel electrode, so that a liquid crystal display panel using the pixel structure 10 may have advantages of increased viewing angle and improved transmittance.

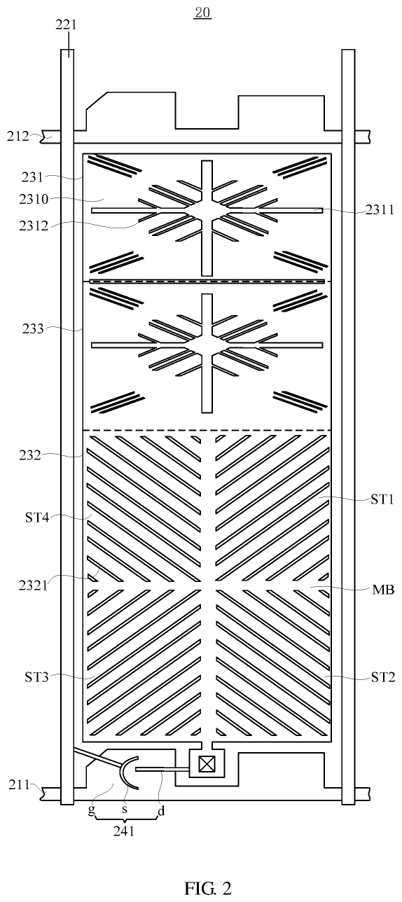

Referring to FIG. 2, a pixel structure 20 provided by another embodiment of the disclosure includes: a scan line 211, a data line 221 disposed intersecting with the scan line 211, and a pixel unit disposed at an intersection of the scan line 211 and the data line 221. The pixel unit includes an active switch group and a pixel electrode group, and the pixel electrode group is connected to the scan line 211 and the data line 221 through the active switch group.

The pixel electrode group includes a first electrode region 231, a second electrode region 232 and a third electrode region 233. The first electrode region 231 is disposed with mutually crossed and communicated hollow long slots 2311 to form multiple first electrode sub-regions 2310, each of the first electrode sub-regions 2310 has multiple short slots 2312 disposed in parallel and inclined relative to the hollow long slots 2311, and orientation directions of the short slots 2312 of the respective first electrode sub-regions 2310 are different from one another. The second electrode region 232 is disposed with mutually crossed solid main parts MB to form multiple second electrode sub-regions, and in the illustrated embodiment, are four second electrode sub-regions, as shown in FIG. 2, sequentially being ST1, ST2, ST3, ST4. The four second electrode sub-regions each have multiple slits 2321 disposed in parallel and inclined relative to the solid main parts MB. Orientation directions of the slits 2321 of the four second electrode sub-regions ST1, ST2, ST3 and ST4 respectively are different from one another.

In particular, the first electrode region 231 includes crossed e.g., perpendicularly crossed and mutually communicated two long slots 2311 and multiple short slots 2312 with different orientation directions, and the short slots 2312 are formed laterally extending from the two long slots 2311; and the pixel electrode in the electrode region usually is called as snowflake-shaped electrode.

The second electrode region 232 includes crossed main parts MB to form four electrode sub-regions ST1, ST2, ST3, and ST4; and the orientation directions of the slits 2321 of the four electrode sub-regions respectively are different from one another. In particular, the second electrode region 232 for example includes crossed e.g., criss-crossed main parts MB to form four electrode sub-regions i.e., ST1, ST2, ST3 and ST4; and the orientation directions of the slits 2321 of the four electrode sub-regions respectively are different from one another, for example respectively are 45 degrees of orientation direction, 135 degrees of orientation direction, 225 degrees of orientation direction and 315 degrees of orientation direction; and the pixel electrode in the electrode region usually is a four-domain electrode.

The third electrode region 233 has a structure similar to that of the first electrode region 231, and thus will not be described in detail.

The active switch group includes an active switching element 241, and the pixel electrode group includes a pixel electrode. In the illustrated embodiment, the pixel electrode typically is a transparent electrode such as an ITO electrode. A source electrode s of the active switching element 241 is connected to the data line 221, a gate electrode g of the active switching element 241 is connected to the scan line 211, and a drain electrode d of the active switching element 241 is connected to the pixel electrode.

The sum of areas of the first electrode region 231 and the third electrode region 233 in the illustrated embodiment is equal to an area of the second electrode region 232, in other words, the second electrode region 232 may be disposed near the scan line 211 and at the bottom of the pixel electrode, the first electrode region 231 is disposed near another scan line 212 and at the top of the pixel electrode, and the third electrode region 233 is disposed between the first electrode region 231 and the second electrode region 232. Of course, alternatively, it may be that the second electrode region 232 is disposed near the scan line 212 and at the top of the pixel electrode, the first electrode region 231 is disposed near the scan line 211 and at the bottom of the pixel electrode, and the third electrode region 233 is disposed between the first electrode region 231 and the second electrode region 232.

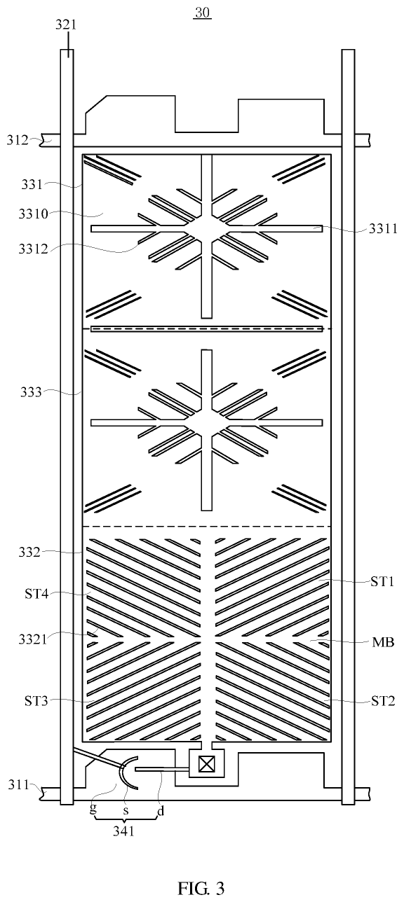

Referring to FIG. 3, a pixel structure 30 provided by still another embodiment of the disclosure includes: a scan line 311, a data line 321 disposed intersecting with the scan line 311, and a pixel unit disposed at an intersection of the scan line 311 and the data line 321. The pixel unit includes an active switch group and a pixel electrode group, and the pixel electrode group is connected to the scan line 311 and the data line 321 through the active switch group.

The pixel electrode group includes a first electrode region 331, a second electrode region 332 and a third electrode region 333. The first electrode region 331 is disposed with mutually crossed and communicated hollow long slots 3311 to form multiple first electrode sub-regions 3310, each of the first electrode sub-regions 3310 has multiple short slots 3312 disposed in parallel and inclined relative to the hollow long slots 3311, and orientation directions of the short slots 3312 of the respective first electrode sub-regions 3310 are different from one another. The second electrode region 332 is disposed with mutually crossed solid main parts MB to form multiple second electrode sub-regions, and in the illustrated embodiment, are four second electrode sub-regions, as shown in FIG. 3, sequentially being ST1, ST2, ST3, ST4. The four second electrode sub-regions each have multiple slits 3321 disposed in parallel and inclined relative to the solid main parts MB. Orientation directions of the slits 3321 of the four second electrode sub-regions ST1, ST2, ST3, ST4 respectively are different from one another.

In particular, the first electrode region 331 includes crossed e.g., perpendicularly crossed and mutually communicated two long slots 3311 and multiple short slots 3312 with different orientation directions, and the short slots 3312 are formed laterally extending from the two long slots 3311, and the pixel electrode in the electrode region usually is called as snowflake-shaped electrode.

The second electrode region 332 includes crossed main parts MB to form four electrode sub-regions ST1, ST2, ST3, and ST4; and the orientation directions of the slits 3321 of the four electrode sub-regions respectively are different from one another. In particular, the second electrode region 332 for example includes crossed e.g., criss-crossed main parts MB to form four electrode sub-regions i.e., ST1, ST2, ST3 and ST4; and the orientation directions of the slits 3321 of the four electrode sub-regions respectively are different from one another, for example respectively are 45 degrees of orientation direction, 135 degrees of orientation direction, 225 degrees of orientation direction and 315 degrees of orientation direction; and the pixel electrode in the electrode region usually is a four-domain electrode.

The third electrode region 333 has a structure similar to that of the first electrode region 331, and thus will not be described in detail.

The active switch group includes an active switching element 341, and the pixel electrode group includes a pixel electrode. In the illustrated embodiment, the pixel electrode typically is a transparent electrode such as ITO electrode. A source electrode s of the active switching element 341 is connected to the data line 321, a gate electrode g of the active switching element 341 is connected to the scan line 311, and a drain electrode d of the active switching element 341 is connected to the pixel electrode.

Areas of the first electrode region 331, the second electrode region 332 and the third electrode region 333 in the illustrated embodiment are equal, in other words, the three regions each occupy one third of the entire area of the pixel electrode. The second electrode region 332 may be disposed near the scan line 311 and at the bottom of the pixel electrode, the first electrode region 331 is disposed near another scan line 312 and at the top of the pixel electrode, and the third electrode region 333 is disposed between the first electrode region 331 and the second electrode region 332. Of course, alternatively, it may be that the second electrode region 332 is disposed near the scan line 312 and at the top of the pixel electrode, the first electrode region 331 is disposed near the scan line 311 and at the bottom of the pixel electrode, and the third electrode region 333 is disposed between the first electrode region 331 and the second electrode region 332.

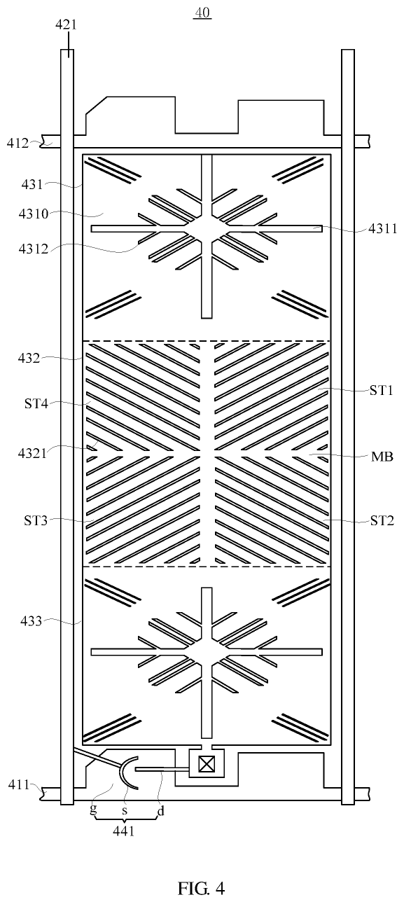

Referring to FIG. 4, a pixel structure 40 provided by further still another embodiment of the disclosure includes: a scan line 411, a data line 421 disposed intersecting with the scan line 411, and a pixel unit disposed at an intersection of the scan line 411 and the data line 421. The pixel unit includes an active switch group and a pixel electrode group, and the pixel electrode group is connected to the scan line 411 and the data line 421 through the active switch group.

The pixel electrode group includes a first electrode region 431, a second electrode region 432 and a third electrode region 433. The first electrode region 431 is disposed with mutually crossed and communicated hollow long slots 4311 to form multiple first electrode sub-regions 4310, each of the first electrode sub-regions 4310 has multiple short slots 4312 disposed in parallel and inclined relative to the hollow long slots 4311, and orientation directions of the short slots 4312 of the respective first electrode sub-regions 4310 are different from one another. The second electrode region 432 is disposed with mutually crossed solid main parts MB to form multiple second electrode sub-regions, and in the illustrated embodiment, are four second electrode sub-regions, as shown in FIG. 4, sequentially being ST1, ST2, ST3, ST4. The four second electrode sub-regions each have multiple slits 4321 disposed in parallel and inclined relative to the solid main parts MB. Orientation directions of the slits 4321 of the four second electrode sub-regions ST1, ST2, ST3 and ST4 respectively are different from one another.

In particular, the first electrode region 431 includes crossed e.g., perpendicularly crossed and mutually communicated two long slots 4311 and multiple short slots 4312 with different orientation directions, and the short slots 4312 are formed laterally extending from the two long slots 4311, and the pixel electrode in the electrode region usually is called as snowflake-shaped electrode.

The second electrode region 432 includes crossed main parts MB to form four electrode sub-regions ST1, ST2, ST3 and ST4; and the orientation directions of the slits 4321 of the four electrode sub-regions respectively are different from one another. In particular, the second electrode region 432 for example includes crossed e.g., criss-crossed main parts MB to form four electrode sub-regions i.e., ST1, ST2, ST3 and ST4; and the orientation directions of the slits 4321 of the four electrode sub-regions respectively are different from one another, for example respectively are 45 degrees of orientation direction, 135 degrees of orientation direction, 225 degrees of orientation direction and 315 degrees of orientation direction; and the pixel electrode in the electrode region usually is a four-domain electrode.

The third electrode region 433 has a structure similar to that of the first electrode region 431, and thus will not be described in detail.

The active switch group includes an active switching element 441, and the pixel electrode group includes a pixel electrode. In the illustrated embodiment, the pixel electrode typically is a transparent electrode such as ITO electrode. A source electrode s of the active switching element 441 is connected to the data line 421, a gate electrode g of the active switching element 441 is connected to the scan line 411, and a drain electrode d of the active switching element 441 is connected to the pixel electrode.

Areas of the first electrode region 431, the second electrode region 432 and the third electrode region 433 in the illustrated embodiment are equal, in other words, the three regions each occupy one third of the entire area of the pixel electrode. The third electrode region 433 may be disposed near the scan line 411 and at the bottom of the pixel electrode, the first electrode region 431 is disposed near another scan line 412 and at top of the pixel electrode, and the second electrode region 432 is disposed between the first electrode region 431 and the third electrode region 433. Of course, alternatively, it may be that the third electrode region 433 is disposed near the scan line 412 and at the top of the pixel electrode, the first electrode region 431 is disposed near the scan line 411 and at the bottom of the pixel electrode, and the second electrode region 432 is disposed between the first electrode region 431 and the third electrode region 433.

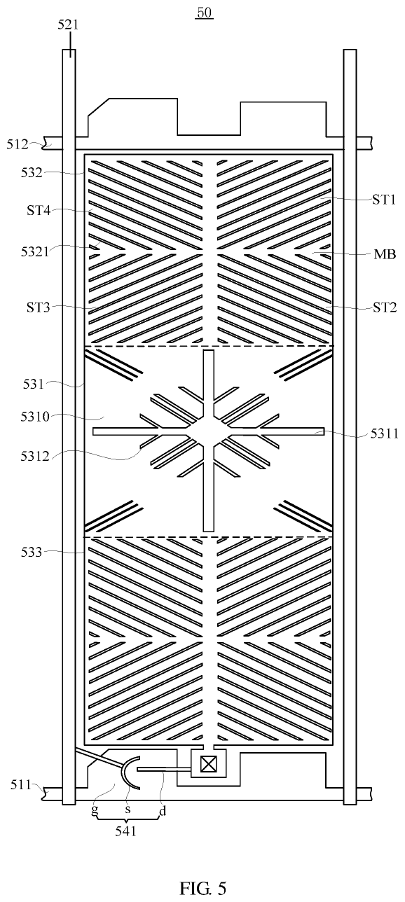

Referring to FIG. 5, a pixel structure 50 provided by even further still another embodiment of the disclosure includes: a scan line 511, a data line 521 disposed intersecting with the scan line 511, and a pixel unit disposed at an intersection of the scan line 311 and the data line 521. The pixel unit includes an active switch group and a pixel electrode group, and the pixel electrode group is connected to the scan line 511 and the data line 521 through the active switch group.

The pixel electrode group includes a first electrode region 531, a second electrode region 532 and a third electrode region 533. The first electrode region 531 is disposed with mutually crossed and communicated hollow long slots 5311 to form multiple first electrode sub-regions 5310, each of the first electrode sub-regions 5310 has multiple short slots 5312 disposed in parallel and inclined relative to the hollow long slots 5311, and orientation directions of the short slots 5312 of the respective first electrode sub-regions 5310 are different from one another. The second electrode region 532 is disposed with mutually crossed solid main parts MB to form multiple second electrode sub-regions, and in the illustrated embodiment, are four second electrode sub-regions, as shown in FIG. 5, sequentially being ST1, ST2, ST3, ST4. The four second electrode sub-regions each have multiple slits 5321 disposed in parallel and inclined relative to the solid main parts MB. Orientation directions of the slits 5321 of the four second electrode sub-regions ST1, ST2, ST3 and ST4 respectively are different from one another.

In particular, the first electrode region 531 includes crossed e.g., perpendicularly crossed and mutually communicated two long slots 5311 and multiple short slots 5312 with different orientation directions, and the short slots 5312 are formed laterally extending from the two long slots 5311, and the pixel electrode in the electrode region usually is called as snowflake-shaped electrode.

The second electrode region 532 includes crossed main parts MB to form four electrode sub-regions ST1, ST2, ST3 and ST4; and the orientation directions of the slits 5321 of the four electrode sub-regions respectively are different from one another. In particular, the second electrode region 532 for example includes crossed e.g., criss-crossed main parts MB to form four electrode sub-regions i.e., ST1, ST2, ST3 and ST4; and the orientation directions of the slits 5321 of the four electrode sub-regions respectively are different from one another, for example respectively are 45 degrees of orientation direction, 135 degrees of orientation direction, 225 degrees of orientation direction and 315 degrees of orientation direction; and the pixel electrode in the electrode region usually is a four-domain electrode.

The third electrode region 533 has a structure similar to that of the second electrode region 532, and thus will not be described in detail.

The active switch group includes an active switching element 541, and the pixel electrode group includes a pixel electrode. In the illustrated embodiment, the pixel electrode typically is a transparent electrode such as ITO electrode. A source electrode s of the active switching element 541 is connected to the data line 521, a gate electrode g of the active switching element 541 is connected to the scan line 511, and a drain electrode d of the active switching element 541 is connected to the pixel electrode.

Areas of the first electrode region 531, the second electrode region 532 and the third electrode region 533 in the illustrated embodiment are equal, in other words, the three regions each occupy one third of the entire area of the pixel electrode. The second electrode region 532 may be disposed near another scan line 512 and at the top of the pixel electrode, the third electrode region 533 is disposed near the scan line 511 and at the bottom of the pixel electrode, and the first electrode region 531 is disposed between the second electrode region 532 and the third electrode region 533. Of course, alternatively, it may be that the second electrode region 532 is disposed near the scan line 511 and at the bottom of the pixel electrode, the third electrode region 533 is disposed near the scan line 512 and at the top of the pixel electrode, and the first electrode region 531 is disposed between the second electrode region 532 and the third electrode region 533.

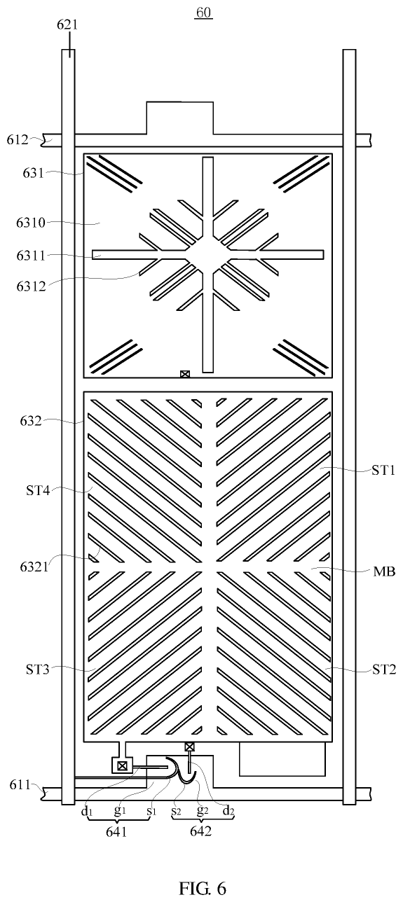

Referring to FIG. 6, a pixel structure 60 provided by even further another embodiment of the disclosure includes: a scan line 611, a data line 621 disposed intersecting with the scan line 611, and a pixel unit disposed at an intersection of the scan line 611 and the data line 621. The pixel unit includes an active switch group and a pixel electrode group, and the pixel electrode group is connected to the scan line 611 and the data line 621 through the active switch group.

The pixel electrode group includes a first electrode region 631 and a second electrode region 632. The first electrode region 631 is disposed with mutually crossed and communicated hollow long slots 6311 to form multiple (i.e., more than one) first electrode sub-regions 6310. Each of the first electrode sub-regions 6310 has multiple short slots 6312 disposed in parallel and inclined relative to the hollow long slots 6311. The short slots 6312 of the respective first electrode sub-regions 6310 have different orientation directions. The second electrode region 632 is disposed with mutually crossed solid main parts MB to form multiple second electrode sub-regions, and in the illustrated embodiment, there is four second electrode sub-regions in total, as shown in FIG. 6, sequentially being ST1, ST2, ST3 and ST4, and each of the four second electrode sub-regions has multiple slits 6321 disposed in parallel and inclined relative to the solid main parts MB. Orientation directions of the slits 6321 of the four second electrode sub-regions ST1, ST2, ST3 and ST4 respectively are different.

The first electrode region 631 includes crossed e.g., perpendicularly crossed and mutually communicated two long slots 6311 and multiple short slots 6312 with different orientation directions, and the short slots 6312 are formed laterally extending from the two long slots 6311; and the pixel electrode in the electrode region usually is snowflake-shaped and thus can be called as snowflake-shaped electrode.

The second electrode region 632 includes crossed main parts MB to form four electrode sub-regions ST1, ST2, ST3 and ST4, and slits 6321 of the fourth electrode sub-regions have different orientation directions. In particular, the second electrode region 632 for example includes crossed e.g., criss-crossed main parts MB to form four electrode sub-regions i.e., ST1, ST2, ST3 and ST4, orientation directions of the slits 6321 of the respective electrode sub-regions are mutually different, e.g., respectively are 45 degrees of orientation direction, 135 degrees of orientation direction, 225 degrees of orientation direction and 315 degrees of orientation direction; and the pixel electrode in the electrode region usually is a four-domain electrode.

The active switch group includes a first active switching element 641 and a second active switching element 642. The pixel electrode group includes a first pixel electrode and a second pixel electrode spaced apart from each other. The first pixel electrode is connected to the scan line 611 and the data line 621 through the first active switching element 641, the second pixel electrode is connected to the scan line 611 and the data line 621 through the second active switching element 641, the first electrode region 631 is used as the first pixel electrode, and the second electrode region 632 is used as the second pixel electrode. In the illustrated embodiment, the first pixel electrode and the second pixel electrode typically are transparent electrodes such as ITO (indium tin oxide) electrodes. A source electrode s1 of the first active switching element 641 is connected to the data line 621, a gate electrode g1 of the first active switching element 641 is connected to the scan line 611, and a drain electrode d1 of the first active switching element 641 is connected to the first pixel electrode. A source electrode s2 of the second active switching element 642 is connected to the data line 621, a gate electrode g2 of the second active switching element 642 is connected to the scan line 611, and a drain electrode d2 of the second active switching element 641 is connected to the second pixel electrode.

A ratio of an area of the first electrode region 631 to an area of the second electrode region 632 is 2:3 or 3:2. In particular, as shown in FIG. 6, the first electrode region 631 is disposed near another scan line 612 and at the top of the pixel electrode group and further the occupied area ratio is two fifth, and the second electrode region 632 is disposed near the scan line 611 and at the bottom of the pixel electrode group and further the occupied area ratio is three fifth. Of course, the positions of the first electrode region 631 and the second electrode region 632 may be interchangeable, i.e., the first electrode region 631 is disposed near the scan line 611 and at the bottom of the pixel electrode and further the occupied area ratio is two fifth, and the second electrode region 632 is disposed near the scan line 612 and at the top of the pixel electrode and further the occupied area ratio is three fifth.

In addition, this embodiment also may be instead that, for example, the first electrode region 631 is disposed near another scan line 612 and at the top of the pixel electrode group and further the occupied area ratio is three fifth, and the second electrode region 632 is disposed near the scan line 611 and at the bottom of the pixel electrode group and further the occupied area ratio is two fifth. Of course, the positions of the first electrode region 631 and the second electrode region 632 may be interchangeable, i.e., the first electrode region 631 is disposed near the scan line 611 and at the bottom of the pixel electrode and further the occupied area ratio is three fifth, and the second electrode region 632 is disposed near the scan line 612 and at the top of the pixel electrode and further the occupied area ratio is two fifth.

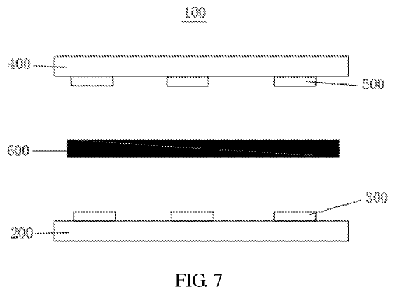

Referring to FIG. 7, in other embodiment of the disclosure, a liquid crystal display panel 100 as provided includes: an active switch array substrate 200 including multiple pixel structures 300, a counter substrate 400 disposed opposite to the active switch array substrate 200, and a liquid crystal layer 600 disposed between the active switch array substrate 200 and the counter substrate 400. The counter substrate 400 for example is a color filter substrate disposed with color filters and a common electrode. In another embodiment, the color filters 500 may be disposed on the active switch array substrate 200 rather than the counter substrate 400.

The pixel structures 300 are the pixel structures as described in foregoing embodiments, for example one or multiple of the pixel structures 10 through 60.

In the several embodiments provided by the disclosure, it should be understood that the described systems, devices and/or methods can be realized in other ways. For example, the embodiments of devices described above are merely illustrative. For example, division of units is only a logical functional division, and other division manner may be adopted in actual implementation, for example multiple units or components can be combined together or integrated into another system, or some features can be omitted or not implemented. In addition, the coupling or direct coupling or communication connection shown or discussed may be indirect coupling or communication connection through some interfaces, devices or units, which may be electrical, mechanical or otherwise.

The units described as separation parts may or may not be physically separated, and the parts shown as units may or may not be physical units, i.e., may be located in one place or distributed over multiple network units. Some or all of the units can be selected according to actual needs to achieve the purpose of the embodiments of the disclosure.

Finally, it should be noted that the above embodiments are merely illustrative of technical solutions of the disclosure and are not intended to be limiting thereof. Although the disclosure is described in detail with reference to the foregoing embodiments, a person skilled in the art should be understood that the technical solutions described in the foregoing embodiments can be modified or some of technical features can be equivalently replaced, and these modifications or replacements do not depart from the spirit and scope of the technical solutions of various embodiments of the disclosure.

What is claimed is:

1. A pixel structure comprising:
a scan line;
a data line, disposed intersecting with the scan line; and
a pixel unit, disposed at an intersection of the scan line and the data line, wherein the pixel unit comprises an active switch group and a pixel electrode group, the pixel electrode group is connected to the scan line and the data line through the active switch group;
wherein the pixel electrode group comprises:
a first electrode region, disposed with mutually crossed and communicated hollow long slots to form a plurality of first electrode sub-regions, wherein each of the first electrode sub-regions has a plurality of short slots disposed in parallel and inclined relative to the hollow long slots, and the short slots of the respective first electrode sub-regions have different orientation directions; and
a second electrode region, disposed with mutually crossed solid main parts to form a plurality of second electrode sub-regions, wherein each of the second electrode sub-regions has a plurality of slits disposed in parallel and inclined relative to the solid main parts, and the slits of the respective second electrode sub-regions having different orientation directions;
wherein the active switch group comprises an active switching element, the pixel electrode group comprises a pixel electrode, and the pixel electrode is connected to the scan line and the data line through the active switching element;
wherein the pixel electrode group further comprises:
a third electrode region, disposed with mutually crossed and communicated second hollow long slots to form a plurality of third electrode sub-regions, wherein each of the third electrode sub-regions has a plurality of second short slots disposed in parallel and inclined relative to the second hollow long slots, and the second short slots of the respective third electrode sub-regions have different orientation directions;
wherein the first electrode region, the second electrode region and the third electrode region are different parts of the same pixel electrode;
wherein the third electrode region is located between the first electrode region and the second electrode region, and the sum of areas of the first electrode region and the third electrode regions is equal to an area of the second electrode region; or, the third electrode region is located between the first electrode region and the second electrode region, and the first electrode region, the second electrode region and the third electrode region have equal areas; or, the second electrode region is located between the first electrode region and the third electrode region, and the first electrode region, the second electrode region and the third electrode region have equal areas.

2. A pixel structure comprising:
a scan line;
a data line, disposed intersecting with the scan line; and
a pixel unit, disposed at an intersection of the scan line and the data line, wherein the pixel unit comprises an active switch group and a pixel electrode group, the pixel electrode group is connected to the scan line and the data line through the active switch group;
wherein the pixel electrode group comprises:
a first electrode region, disposed with mutually crossed and communicated hollow long slots to form a plurality of first electrode sub-regions, wherein each of the first electrode sub-regions has a plurality of short slots disposed in parallel and inclined relative to the hollow long slots, and the short slots of the respective first electrode sub-regions have different orientation directions; and
a second electrode region, disposed with mutually crossed solid main parts to form a plurality of second electrode sub-regions, wherein each of the second electrode sub-regions has a plurality of slits disposed in parallel and inclined relative to the solid main parts, and the slits of the respective second electrode sub-regions having different orientation directions.

3. The pixel structure as claimed in claim 2, wherein the active switch group comprises an active switching element, the pixel electrode group comprises a pixel electrode, and the pixel electrode is connected to the scan line and the data line through the active switching element; the first electrode region and the second electrode regions respectively are two parts of the same pixel electrode with equal areas.

4. The pixel structure as claimed in claim 2, wherein the active switch group comprises an active switching element, the pixel electrode group comprises a pixel electrode, and the pixel electrode is connected to the scan line and the data line through the active switching element;
wherein the pixel electrode group further comprises:
a third electrode region, disposed with mutually crossed and communicated second hollow long slots to form a plurality of third electrode sub-regions, wherein each of the third electrode sub-regions has a plurality of second short slots disposed in parallel and inclined relative to the second hollow long slots, and the second short slots of the respective third electrode sub-regions have different orientation directions;
wherein the first electrode region, the second electrode region and the third electrode region respectively are different parts of the same pixel electrode.

5. The pixel structure as claimed in claim 4, wherein the sum of areas of the first electrode region and the third electrode region is equal to an area of the second electrode region.

6. The pixel structure as claimed in claim 5, wherein the third electrode region is located between the first electrode region and the second electrode region.

7. The pixel structure as claimed in claim 4, wherein the third electrode region is located between the first electrode region and the second electrode region, and areas of the first electrode region, the second electrode region and the third electrode region are equal.

8. The pixel structure as claimed in claim 4, wherein the second electrode region is located between the first electrode region and the third electrode region, and areas of the first electrode region, the second electrode region and the third electrode region are equal.

9. The pixel structure as claimed in claim 2, wherein the active switch group comprises an active switching element, the pixel electrode group comprises a pixel electrode, and the pixel electrode is connected to the scan line and the data line through the active switching element;
wherein the pixel electrode group further comprises:
a third electrode region, disposed with mutually crossed second solid main parts to form a plurality of third electrode sub-regions, wherein each of the third electrode sub-regions has a plurality of second slits disposed in parallel and inclined relative to the second solid main parts, and the second slits of the respective third electrode sub-regions have different orientation directions;
wherein the first electrode region, the second electrode region and the third electrode region respectively are different parts of the same pixel electrode.

10. The pixel structure as claimed in claim 9, wherein the first electrode region is located between the second electrode region and the third electrode region, and areas of the first electrode region, the second electrode region and the third electrode region are equal.

11. The pixel structure as claimed in claim 2, wherein the active switch group comprises a first active switching element and a second active switching element, the pixel electrode group comprises a first pixel electrode and a second pixel electrode spaced apart from each other, the first pixel electrode is connected to the scan line and the data line through the first active switching element, the second pixel electrode is connected to the scan line and the data line through the second active switching element; the first electrode region is used as the first pixel electrode, and the second electrode region is used as the second pixel electrode.

12. The pixel structure as claimed in claim 11, wherein an area of the first electrode region is different from an area of the second electrode region.

13. The pixel structure as claimed in claim 12, wherein a ratio of the area of the first electrode region to the area of the second electrode region is 2:3 or 3:2.

14. A liquid crystal display panel comprising:
an active switch array substrate, comprising a plurality of pixel structures;
a counter substrate, disposed opposite to the active switch array substrate;
a liquid crystal layer, disposed between the active switch array substrate and the counter substrate;
wherein at least one of the pixel structures comprises:
a scan line;
a data line, disposed intersecting with the scan line; and
a pixel unit, disposed at an intersection of the scan line and the data line, wherein the pixel unit comprises an active switch group and a pixel electrode group, the pixel electrode group is connected to the scan line and the data line through the active switch group;
wherein the pixel electrode group comprises:
a first electrode region, disposed with mutually crossed and communicated hollow long slots to form a plurality of first electrode sub-regions, wherein each of the first electrode sub-regions has a plurality of short slots disposed in parallel and inclined relative to the hollow long slots, and the short slots of the respective first electrode sub-regions have different orientation directions; and
a second electrode region, disposed with mutually crossed solid main parts to form a plurality of second electrode sub-regions, wherein each of the second electrode sub-regions has a plurality of slits disposed in parallel and inclined relative to the solid main parts, and the slits of the respective second electrode sub-regions having different orientation directions.

15. The liquid crystal display panel as claimed in claim 14, wherein the active switch group comprises an active switching element, the pixel electrode group comprises a pixel electrode, and the pixel electrode is connected to the scan line and the data line through the active switching element;
wherein the pixel electrode group further comprises:
a third electrode region, disposed with mutually crossed and communicated second hollow long slots to form a plurality of third electrode sub-regions, wherein each of the third electrode sub-regions has a plurality of second short slots disposed in parallel and inclined relative to the second hollow long slots, and the second short slots of the respective third electrode sub-regions have different orientation directions;
wherein the first electrode region, the second electrode region and the third electrode region respectively are different parts of the same pixel electrode.

16. The liquid crystal display panel as claimed in claim 15, wherein the third electrode region is located between the first electrode region and the second electrode region, and the sum of areas of the first electrode region and the third electrode region is equal to an area of the second electrode region; or, the third electrode region is located between the first electrode region and the second electrode region, and areas of the first electrode region, the second electrode region and the third electrode region are equal; or, the second electrode region is located between the first electrode region and the third electrode region, and areas of the first electrode region, the second electrode region and the third electrode region are equal.

17. The liquid crystal display panel as claimed in claim 14, wherein the active switch group comprises an active switching element, the pixel electrode group comprises a pixel electrode, and the pixel electrode is connected to the scan line and the data line through the active switching element;
wherein the pixel electrode group further comprises:
a third electrode region, disposed with mutually crossed second solid main parts to form a plurality of third electrode sub-regions, wherein each of the third electrode sub-regions has a plurality of second slits disposed in parallel and inclined relative to the second solid main parts, and the second slits of the respective third electrode sub-regions have different orientation directions;
wherein the first electrode region, the second electrode region and the third electrode region respectively are different parts of the same pixel electrode.

18. The liquid crystal display panel as claimed in claim 17, wherein the first electrode region is located between the second electrode region and the third electrode region, and areas of the first electrode region, the second electrode region and the third electrode region are equal.

19. The liquid crystal display panel as claimed in claim 14, wherein the active switch group comprises a first active switching element and a second active switching element, the pixel electrode group comprises a first pixel electrode and a second pixel electrode spaced apart from each other, the first pixel electrode is connected to the scan line and the data line through the first active switching element, the second pixel electrode is connected to the scan line and the data line through the second active switching element; the first electrode region is used as the first pixel electrode, and the second electrode region is used as the second pixel electrode.

20. The liquid crystal display panel as claimed in claim 19, wherein an area of the first electrode region is different from an area of the second electrode region, and a ratio of the area of the first electrode region to the area of the second electrode region is 2:3 or 3:2.
